(19) United States
(12) Patent Application Publication
(10) Pub. No.: US 2014/0078045 A1
(43) Pub. Date: Mar. 20, 2014

(54) Display Apparatus And Terminal

(71) Applicants: Chengdu BOE Optoelectronics Technology Co. Ltd, Chengdu (CN); BOE Technology Group Co. Ltd, Beijing (CN)

(72) Inventors: Ruizhi Yang, Beijing (CN); Junhwan Lim, Beijing (CN); Junrui Zhang, Beijing (CN)

(73) Assignees: Chengdu BOE Optoelectronics Technology Co., Ltd., Chengdu (CN); BOE Technology Group Co., Ltd., Beijing (CN)

(21) Appl. No.: 13/983,656

(22) PCT Filed: Mar. 12, 2013
(86) PCT No.: PCT/CN2013/072486

§ 371 Date: Aug. 5, 2013

(30) Foreign Application Priority Data
Mar. 14, 2012 (CN) 20122009607.1

(51) Int. Cl. G06F 3/01

(52) U.S. Cl. CPC G06F 3/01
USPC 345/156

(57) ABSTRACT

The embodiments of the present invention provide a display apparatus and a terminal. The display apparatus comprises a display panel (101) and a 3D switching device (102), and a connection between a frame (103) of the 3D switching device (102) and the display panel (101) is a movable connection.

### TECHNICAL FIELD

Embodiments of the present invention relate to a display apparatus and a terminal.

### BACKGROUND

FIG. 1 is a structural schematic view of a 3D display apparatus in conventional art, and FIG. 2 is a view of light path when the 3D display apparatus in conventional art displays an image. As shown in FIG. 1, the 3D display apparatus comprises a display panel 101 and a parallax barrier 102, the parallax barrier 102 is mounted in a frame 103, and the display panel 101 and the frame 103 are fixed and installed together. As shown in FIG. 2, when the display apparatus shows two images having horizontal parallax that are produced in different viewing angles similar to two eyes of a person, the parallax barrier 102 causes the left eye A of a viewer to observe the image taken from the left viewing angle and causes the right eye B of the viewer to observe the image taken from the right viewing angle.

In the conventional art, the display panel 101 and the parallax barrier 102 in the 3D display apparatus are fixed and installed together, the light from the display panel 101 have to pass through the parallax barrier 102 at all times, in this case, there exists a certain degree of loss in the light that eventually enters the eyes of the viewer so that the brightness of the 3D display apparatus is reduced. As to the 3D display, the parallax barrier 102 is absolutely necessary, thus its adverse influence on the brightness of the 3D display apparatus is inevitable. However, when the 3D display apparatus is used for the 2D display, the brightness of the 2D display image is reduced as well due to the existence of the parallax barrier 102 on the display panel 102.

### SUMMARY

According to one embodiment of the present invention, there is provided a display apparatus. The display apparatus comprises a display panel and a 3D switching device. A connection between a frame of the 3D switching device and the display panel is a movable connection

According to another embodiment of the present invention, there is provided a terminal comprising the above display apparatus.

### BRIEF DESCRIPTION OF DRAWINGS

In order to describe the technical solutions of the embodiments of the present invention, it will give a brief description to the figures of the embodiments below. Obviously, the below described figures are only relate some embodiments of the present invention, and not intended to restrict the present invention.

FIG. 1 is a structural schematic view of a 3D display apparatus in conventional art;

FIG. 2 is a view of light path when the 3D display apparatus in conventional art displays an image;

FIG. 3 is a structural schematic view of a display apparatus according to a first embodiment of the present invention; and

FIG. 4 is a structural schematic view of a display apparatus according to a second embodiment of the present invention.

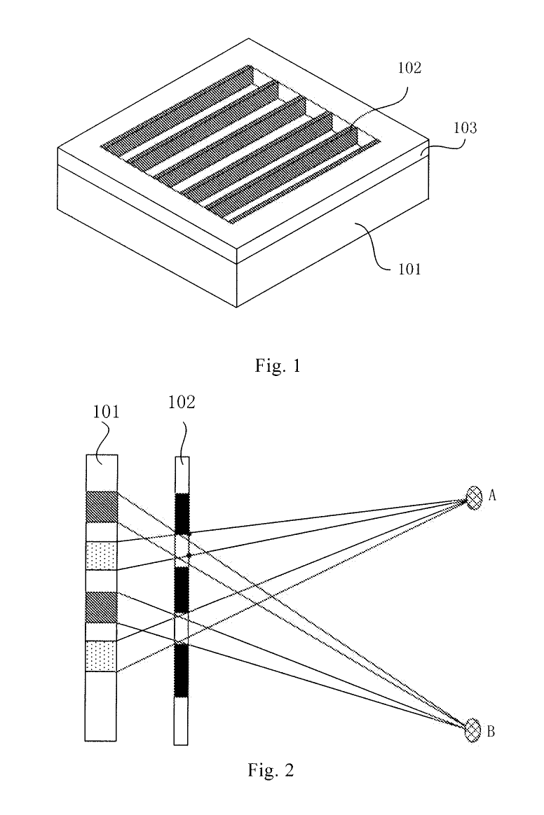

### DETAILED DESCRIPTION

In order to make aims, technical solution and advantages of the embodiments of the present invention to be clearer, the technical solutions of the embodiments of the present invention will be described below clearly and fully in connection with the figures of the embodiments of the present invention. Obviously, the described embodiments are a portion of the embodiments of the present invention, not to be all embodiments. Based on the described embodiments of the present invention, all additional embodiments, which could be obtained by those with ordinary skills in the art without paying creative work, belong to the scope of the protection of the present invention.

According to the embodiments of the present invention, the display apparatus comprises a display panel and a 3D switching device. The 3D switching device may be a parallax barrier, a lenticular lens, a phase retardation film or other switching devices. As shown in FIG. 2, the 3D switching device causes the right eye A of the viewer to observe the image taken from the right viewing angle and causes the left eye B of the viewer to observe the image taken from the left viewing angle, so that the 3D display is achieved. The following descriptions will be made based on the case that the 3D switching device is the parallax barrier. In the display apparatus, the connection between a frame of the parallax barrier and the display panel is a movable connection. The “movable connection” refers to that the parallax barrier and the display panel are capable of engaging or disengaging with each other depending on the practical requirements. When the display panel and the parallax barrier are engaged with each other, the display panel is controlled to perform the 3D display, light from the display panel reaches the left and right eyes of the viewer through the parallax barrier, and at this time, the left eye of the viewer only observes the image for the left eye and the right eye of the viewer only observes the image for the right eye so that the 3D display is achieved. When the display panel and the parallax barrier are disengaged with each other, the display panel is controlled to perform the 2D display, and at this time, the 2D image from the display panel directly enters the eyes of the viewer without passing through the parallax barrier. In this way, the switch between the 2D display and the 3D display can be performed rapidly and conveniently, and the brightness of the 2D image displayed by the display apparatus can be increased because the display panel can display the 2D image directly to the viewer.

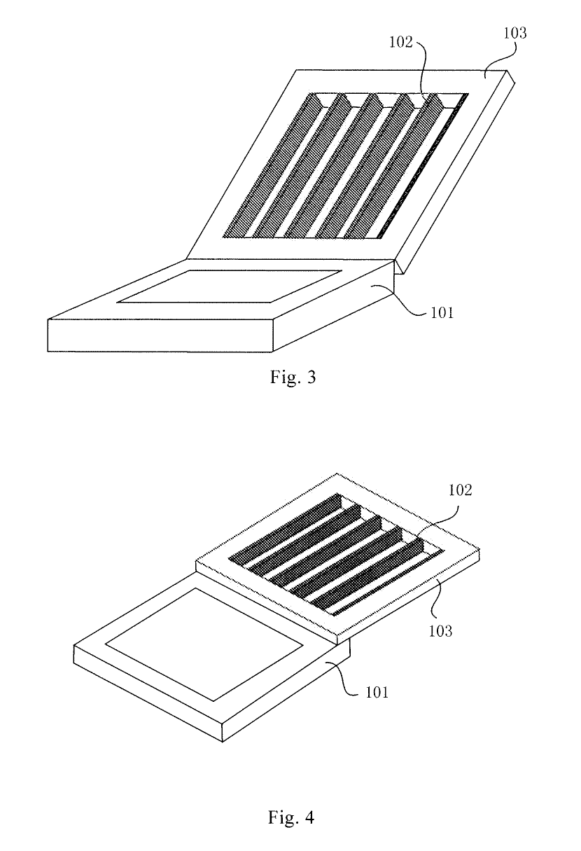

FIG. 3 is a structural schematic view of a display apparatus according to a first embodiment of the present invention. As shown in FIG. 3, the display apparatus in the present embodiment comprises a display panel 101 and a parallax barrier 102. The parallax barrier 102 has a frame 103, and the frame 103 and the display panel 101 are connected with each other by shaft. The shaft is parallel to the surface of the display panel 101. The frame 103 and the display panel 101 may rotate with respect to the shaft so that the parallax barrier 102 provided in the frame 103 and the display panel 101 are capable of engaging or disengaging with each other. When the parallax barrier 102 and the display panel 101 are engaged with each other, the light from the display panel 101 passes through the parallax barrier 102, the display apparatus performs the 3D display and the viewer observes the 3D image displayed by the display apparatus. When the parallax barrier 102 and the display panel 101 are disengaged with each other, the light from the display panel 101 does not pass through the parallax barrier 102, the display apparatus performs the 2D display and the viewer directly observes the 2D image outputted by the display panel 101. In this case, the brightness of the 2D image displayed by the display apparatus can be increased.

Further, the shaft may be perpendicular to the surface of the display panel 101. In this case, the shaft may be installed at any one of the four corners of the display panel 101. The frame 103 may rotate with respect to the shaft, so that the parallax barrier 102 provided in the frame 103 and the display panel 101 are capable of engaging or disengaging with each other rapidly and conveniently and the brightness of the 2D image displayed by the display apparatus can be increased.

In the present embodiment, by employing the movable connection between the display panel and the 3D switching device such as the parallax barrier, the display apparatus can perform the switch between the 2D display and the 3D display rapidly and conveniently. When the 3D switching device such as the parallax barrier is disengaged with the display panel, the display panel displays the 2D image directly to the viewer and the brightness loss of the 2D image does not occur. Thus, the brightness of the 2D image displayed by the display apparatus can be increased and the power consumption of the display apparatus can be decreased.

FIG. 4 is a structural schematic view of a display apparatus according to a second embodiment of the present invention. As shown in FIG. 4, a guide rail is disposed on the display panel 101 of the display apparatus of the present embodiment, the parallax barrier 102 has a frame 103 and the frame 103 of the parallax barrier 102 is installed on the guide rail. The frame 103 may move along the guide rail on the display panel 101. The user may control the frame 103 to reciprocate along the guide rail on the display panel 101 in a push and pull manner, so that the parallax barrier 102 and the display panel 101 are capable of engaging or disengaging with each other. By adjusting the direction of the guide rail on the display panel 101, the parallax barrier may move upward or downward along the guide rail of the display panel, or the parallax barrier may move leftward or rightward along the guide rail of the display panel. Alternatively, according to the practical requirements, the parallax barrier 102 may move in other direction along the guide rail of the display panel 101 by adjusting the direction of the guide rail on the display panel 101.

Further, in the display apparatus according to the above embodiments, the parallax barrier 102 may be a pattern-changeable parallax barrier. The pattern-changeable parallax barrier is a parallax barrier in which the grids are changeable. For example, the pattern-changeable parallax barrier may be a liquid crystal parallax barrier, a parallax barrier made by electrochromism material or other types of changeable parallax barrier. The width of a non-transmissive region and the width of a transmissive region in the parallax barrier 102 may be adjusted according to a distance between the eyes of the viewer and the parallax barrier 102, and this adjusting process may comprises the following steps:

determining positions of the eyes of the viewer and measuring the distance between the eyes of the viewer and the parallax barrier 102 by a sensor; calculating an optical size of the parallax barrier 102 that is required to guarantee the best display effect by a controller according to the above measured distance, wherein the optical size of the parallax barrier 102 comprises the widths of the non-transmissive region and the transmissive region in the parallax barrier 102; adjusting the widths of the non-transmissive region and the transmissive region in the parallax barrier 102 by the controller according to the above calculated results , so that the light from the display panel 101 respectively enters the left and right eyes of the viewer through the parallax barrier 102 and the viewer observes the 3D image with the best effect.

In addition, the display apparatus according to the above embodiments may further comprise a memory device, and the memory device is disposed on the frame 103 and is connected with the above sensor. The memory device stores a mapping table between the distance that is between the eyes of the viewer and the parallax barrier 102 and the optical size of the parallax barrier 102. When the distance between the eyes of the viewer and the parallax barrier 102 measured by the sensor is received, the optical size of the parallax barrier 102 is obtained directly according to the mapping table, and then the widths of the non-transmissive region and the width of the transmissive region are adjusted by the controller. In this way, the step of calculating the optical size of the parallax barrier 102 according to the distance between the eyes of the viewer and the parallax barrier 102 is omitted, and thus the speed of adjusting the optical size of the parallax barrier 102 can be improved.

In practical applications, a speaker, a headphone and the like may be further mounted on the frame 103, in this case, the volume of the display apparatus can be reduced and the user's requirements can be satisfied better.

The embodiments of the invention further provide a terminal. The terminal may be a cellular phone, a personal digital assistant (PDA), a flat panel computer, a MP4 and the like. The terminal comprises the display apparatus shown in FIG. 3 or FIG. 4. Therefore, the terminal can perform the switch between the 2D display and the 3D display rapidly and conveniently. In addition, after the parallax barrier and the display panel are disengaged with each other, the display panel displays the 2D image directly to the viewer, so that the brightness of the 2D image can be improved and the power consumption of the terminal can be saved as well.

The foregoing embodiments merely are exemplary embodiments of the invention, and not intended to define the scope of the invention, and the scope of the invention is determined by the appended claims.

What is claimed is:

1. A display apparatus, comprising:
a display panel and a 3D switching device;
wherein a connection between a frame of the 3D switching device and the display panel is a movable connection.

2. The display apparatus of claim 1, wherein the 3D switching device is a parallax barrier, a lenticular lens or a phase retardation film.

3. The display apparatus of claim 1, wherein the frame of the 3D switching device and the display panel are connected with each other by a shaft, so that the movable connection between the frame of the 3D switching device and the display panel is achieved.

4. The display apparatus of claim 1, wherein a guide rail is disposed on the display panel and the frame of the 3D switching device is mounted on the guide rail, so that the movable connection between the frame of the 3D switching device and the display panel is achieved.

5. The display apparatus of claim 1, wherein the 3D switching device is a parallax barrier, and the display apparatus further comprises:
a sensor, measuring a distance between the eyes of a viewer and the parallax barrier; and
a controller, calculating and adjusting an optical size of the parallax barrier according to the distance measured by the sensor;
wherein the sensor is disposed on the frame of the parallax.

6. The display apparatus of claim 5, wherein the parallax barrier is a pattern-changeable parallax barrier.

7. The display apparatus of claim 6, wherein the pattern-changeable parallax barrier is a liquid crystal parallax barrier or a parallax barrier made of electrochromism material.

8. The display apparatus of claim 1, wherein the 3D switching device is a parallax barrier, and the display apparatus further comprises:
a sensor, measuring a distance between the eyes of a viewer and the parallax barrier;
a memory device, storing a mapping table between the distance that is between the eyes of the viewer and the parallax barrier and an optical size of the parallax barrier; and
a controller, adjusting the optical size of the parallax barrier according to the distance measured by the sensor.

9. The display apparatus of claim 8, wherein the parallax barrier is a pattern-changeable parallax barrier.

10. The display apparatus of claim 9, wherein the pattern-changeable parallax barrier is a liquid crystal parallax barrier or a parallax barrier made of electrochromism material.

11. The display apparatus of claim 1, wherein a speaker and/or a headphone are further disposed on the frame of the parallax barrier.

12. A terminal, comprising the display apparatus of claim 1.
